(19) United States
(12) Patent Application Publication
(10) Pub. No.: US 2025/0365200 A1
(43) Pub. Date: Nov. 27, 2025

(54) SECURED CLOSED GROUP SERVICES OVER CELLULAR NETWORKS

(71) Applicant: DISH Wireless L.L.C., Littleton, CO (US)

(72) Inventor: Mostafa Tofighbakhsh, Cupertino, CA (US)

(21) Appl. No.: 18/674,432

(22) Filed: May 24, 2024

(51) Int. Cl. H04L 41/0893; H04L 41/16; H04L 67/12

(52) U.S. Cl. CPC H04L 41/0893; H04L 41/16; H04L 67/12

(57) ABSTRACT

Techniques for using a closed group of cellular devices to perform a task are described. An example method includes receiving a request from a device within a cellular network, wherein the request indicates a recommendation for other devices within the cellular network that are available to form a closed group of devices capable of performing the task; determining, by the one or more processors, the other devices that are available within the cellular network and that at least in combination with the device are able to perform the task; wherein the determining includes use of one or more machine learning (ML) models; generating, by the one or more processors, a response that identifies the other devices that, at least in combination with the device, are available to participate with the device to perform the task; and sending, by the one or more processors, the response to the device.

### BACKGROUND

Advancements in cellular communication allow for superior levels of quality of wireless communication, including reliability, range, data connectivity, and high bandwidth. With the advancements in cellular communication and the advent of the Internet of Things (IoT), the field of automation has experienced rapid growth. In many cases, the control and interoperability of these smart devices relies on backend servers and cloud computing solutions. This requires user commands or inputs to be processed at a remote server prior to providing results back to a device. This causes multiple drawbacks, including the necessity for a consistent internet connection to operate a device; privacy and data security concerns due to the transmission of user data to a public source; and latency between devices while communicating. Thus, there remains a significant challenge in providing a system that can efficiently and securely manage these devices.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for secured closed group services over a cellular network. The method also includes receiving, by one or processors, a request from a device within a cellular network, where the request indicates a recommendation for other devices within the cellular network that are available to form a closed group of devices capable of performing a task. The method also includes determining, by the one or more processors, the other devices that are available within the cellular network and that at least in combination with the device are able to perform the task; where the determining includes use of one or more machine learning (ML) models. The method also includes generating, by the one or more processors, a response that identifies the other devices that, at least in combination with the device, are available to participate with the device to perform the task. The method also includes sending, by the one or more processors, the response to the device. Other embodiments of this aspect include corresponding computer systems, apparatus, and computer programs recorded on one or more computer storage devices, each configured to perform the actions of the methods.

Implementations may include one or more of the following features. The method where the response causes the device to establish the closed group with one or more of the other devices; and directly communicate with the other one or more of the other devices to perform the task. The method may include establishing a mesh network that includes the one or more of the other devices. The method may include: obtaining performance data relating to the performance of the task by one or more other devices of the closed group; updating at least one of the one or more ml models using at least a portion of the performance data as a training input; and deploying an updated ml model. Establishing the closed group includes establishing a mesh network that includes the device and the one or more other devices; where the device communicates with the one or more other devices using at least one of unicast messages, or multi-cast messages. The other devices are 5G connected IoT devices. Determining the other devices may include determining one or more groups of devices that are configured to perform at least a portion of the task. Implementations of the described techniques may include hardware, a method or process, or computer software on a computer-accessible medium.

One general aspect includes a system. The system also includes a device wirelessly connected to a cellular network. The system also includes a group service wirelessly connected to the cellular network that is configured to: receive a request from the device, where the request indicates a recommendation for other devices within the cellular network that are available to form a closed group of devices capable of performing a task; determine the other devices that are available within the cellular network and that at least in combination with the device are able to perform the task; where the determining includes use of one or more machine learning (ML) models; generate a response that identifies the other devices that, at least in combination with the device, are available to participate with the device to perform the task; and provide the response to the device. Other embodiments of this aspect include corresponding computer systems, apparatus, and computer programs recorded on one or more computer storage devices, each configured to perform the actions of the methods.

Implementations may include one or more of the following features. The system where the device is configured to: determine selected devices from the other devices; and establish the closed group with selected devices. The group service is further configured to: obtain performance data relating to the performance of the task by one or more other devices of the closed group; update at least one of the one or more ml models using at least a portion of the performance data as a training input; and deploy an updated ml model. Establishing the closed group includes establishing a mesh network that includes the device and the one or more other devices; where the device communicates with the one or more other devices using at least one of unicast messages, or multi-cast messages. The device is configured to: establish a closed group with one or more of the other devices; and directly communicate with the other one or more of the other devices to perform the task. The device is further configured to establish a mesh network that includes the one or more of the other devices. The device and the other devices are 5G IoT devices. Determining the other devices may include determining one or more groups of devices that are configured to perform at least a portion of the task. Implementations of the described techniques may include hardware, a method or process, or computer software on a computer-accessible medium.

One general aspect includes a non-transitory computer-readable storage media storing computer-executable instructions that when executed by the one or more processors. The non—transitory computer—readable storage media storing computer—executable instructions also includes receive a request from a device within a cellular network, where the request indicates a recommendation for other devices within the cellular network that are available to form a closed group of devices capable of performing a task. The instructions also include to determine the other devices that are available within the cellular network and that at least in combination with the device are able to perform the task; where the determining includes use of one or more machine learning (ml) models. The instructions also include to generate a response that identifies the other devices that, at least in combination with the device, are available to participate with the device to perform the task. The instructions also include to send the response to the device. Other embodiments of this aspect include corresponding computer systems, apparatus, and computer programs recorded on one or more computer storage devices, each configured to perform the actions of the methods.

Implementations may include one or more of the following features. The non-transitory computer-readable storage media where the device directly communicates with the one or more of the other devices, within the closed group, to perform the task. The computer-executable instructions when executed, cause the one or more processors to establish a mesh network that includes the one or more of the other devices. The device and the one or more other devices communicate using secured communication channels. The device and the other devices are 5G IoT devices. Implementations of the described techniques may include hardware, a method or process, or computer software on a computer-accessible medium.

### BRIEF DESCRIPTION OF THE DRAWINGS

FIG. 1A illustrates an embodiment of a cellular network system, according to certain embodiments of the present invention.

FIG. 1B illustrates an exemplary core, according to certain embodiments.

FIG. 2 is a schematic diagram illustrating an example communications system that uses closed groups of devices to perform tasks/services, according to various embodiments of the present disclosure.

FIG. 3 is a schematic diagram illustrating an example communications system utilizing a mesh network of 5G devices, and a second mesh network, according to various embodiments of the present disclosure.

FIG. 4A illustrates an example of a neural network 400 that has been trained to generate a recommendation for devices to include within a closed group to perform a task, according to various embodiments of the present disclosure.

FIG. 4B is a diagram illustrating an example of a neuron, according to various embodiments of the present disclosure.

FIG. 5 is a flow diagram illustrating a process for generating a recommendation that identifies available devices within a cellular network to perform a task, according to an embodiment of the present disclosure.

FIG. 6 is a flow diagram illustrating a process for establishing and using a closed group of devices to perform a task

FIG. 7 a flow diagram illustrating a process for training and updating one or more ML models, according to an embodiment of the present disclosure.

FIG. 8 illustrates an example computer system or computer device, according to various embodiments of the present disclosure.

### DETAILED DESCRIPTION

The present disclosure provides systems, devices, and methods generally relate to forming secured closed groups of devices to perform tasks/services over cellular networks. With the recent increases in cellular communication speeds and bandwidth, the use of the Internet of Things (IoT) devices to perform tasks over a cellular network have exploded. Using today's cellular networks (e.g., 5G), a myriad of IoT devices can be used to perform tasks such as security, manufacturing, fleet management, logistics, and the like. The tasks and services provided by IoT devices will only increase over time.

Using techniques described herein, wireless devices, such as IoT devices that can connect to 5G cellular networks, can be interconnected through a cellular network to form closed groups. As used herein, the term “closed group” refers to a group of selected devices that are trusted and authorized to wirelessly communicate directly with each other. In some examples, a mesh network is formed between the devices identified to be within the closed group. These closed groups can provide secure direct communication between the different devices that are part of closed group. In some examples, the devices within the group may use different communication techniques such as unicast, multicast, or broadcast. According to some configurations, some devices within the group may use additional layers of security to protect communications. For example, one device may encrypt data that is sent to one or more of the other devices within the closed group, and not encrypt data that is sent to other devices. Other techniques can be used to protect the communications.

In some examples, the devices within the closed group work together to perform a task (e.g., security, manufacturing, . . . ). Stated another way, the devices coordinate with each other to perform one or more tasks or provide a service. According to some configurations, one or more machine learning (ML) models may be used to determine the devices (e.g., IoT devices) that are available, alone and/or in combination, to perform a specified task/service. For example, for a security task example, some devices may provide monitoring capabilities (e.g., video, sound, infrared, . . . ), other devices may provide locking/unlocking capabilities, and yet other devices may be identified that provided reporting capabilities (e.g., notifying police/fire/authorized part), and the like.

In some configurations, a group service may receive a request from a device (e.g., a 5G IoT device, that may be referred to herein as a “5G device” or “IoT device”, that is connected to a cellular network) for the availability of other devices (e.g., 5G devices) that are near the requesting IoT device to perform at least a portion of a task/service. In response to receiving the request, the group service can identify the available IoT devices within some proximity to the requesting IoT device (e.g., within a predetermined area, within a predetermined distance, . . . ) that are configured to perform at least a portion of the requested task/service. In some examples, the group service uses one or more ML models to identify the type(s) of IoT devices that are needed to perform the requested service/tasks. The ML models may be trained and updated using data obtained directly from the different types of IoT devices available within the cellular network. In some examples, the group service generates a recommendation of available devices that are available to form a closed group with the requesting device and perform the task in coordination with the other devices within the closed group. The group service transmits the recommendation to the requesting device.

In some cases, the ML models may refer to the deployment of artificial intelligence algorithms and models directly on devices, such as 5G devices, that are within a closed group or near a closed group, rather than processing data in centralized data centers or cloud environments. This may assist to minimize latency and reduce reliance on cloud services and remove the necessity of internet connectivity. These devices can include smartphones, IoT devices, industrial machines, and the like. In these examples, the devices may be able to process and analyze data locally on the IoT devices themselves.

After receiving the recommendation of the available devices to perform the task, the requesting device, or some other component/device selects devices from the recommended devices to include within the group. Once the devices are selected, the closed group is established. In some configurations, a mesh network is established that includes the selected devices. The mesh network assists in the coordination and facilitation of the devices within the closed group to perform the task/service. The mesh network also facilitates secure communication. For example, devices within the closed group may create different channels for communication that use different communication methods such as unicast, broadcast, and multi-cast. In some examples, one mesh network that is associated with a first closed group can establish a connection to communicate with one or more other mesh networks that are associated with different closed groups.

In some configurations, the IoT devices within a closed group may act as a server and/or a client device. For example, one or more of the IoT devices in the closed group may be configured to act as a server for one or more portions of a task/service, while other IoT devices in the closed group may be configured to act as a server for other portions of the task/service. In this way, instead of the IoT devices experiencing latency by relying on backend servers, an IoT device near a requesting IoT device may act as the server providing the desired functionality.

Using prior techniques, the IoT devices would request processing to be performed remotely at a backend server. This dependency on processing at a remote location introduces latency as well as reliance on computing resources that may or may not be available when requested. Additionally, the transmission of data to and from the server may introduce data security concerns. This is especially concerning during a time when data breaches are becoming increasingly common. In some cases, the reliance on cloud-based infrastructure can result in noticeable latency between the backend server and the IoT devices. Further, as the number of IoT devices within a household grows, the demand on network bandwidth and backend processing increases, potentially exacerbating these issues.

Aspects of the disclosed technology address these, and other issues, as further discussed herein. Further detail regarding such embodiment and additional embodiments is provided in relation to the figures. Embodiments detailed herein can be used in various types of cellular networks, such as a 5G New Radio (NR) cellular network.

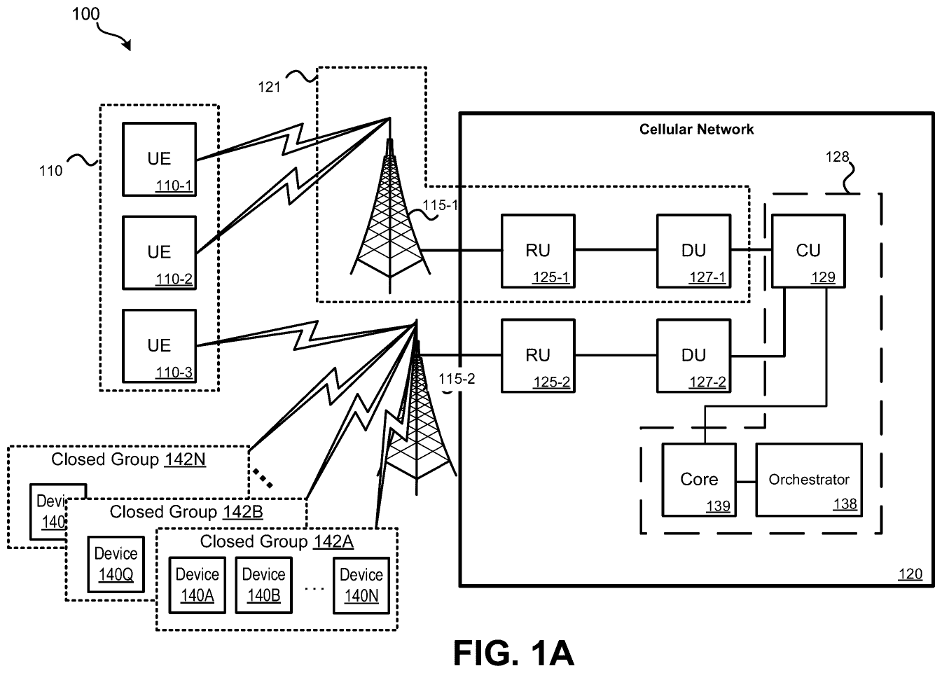

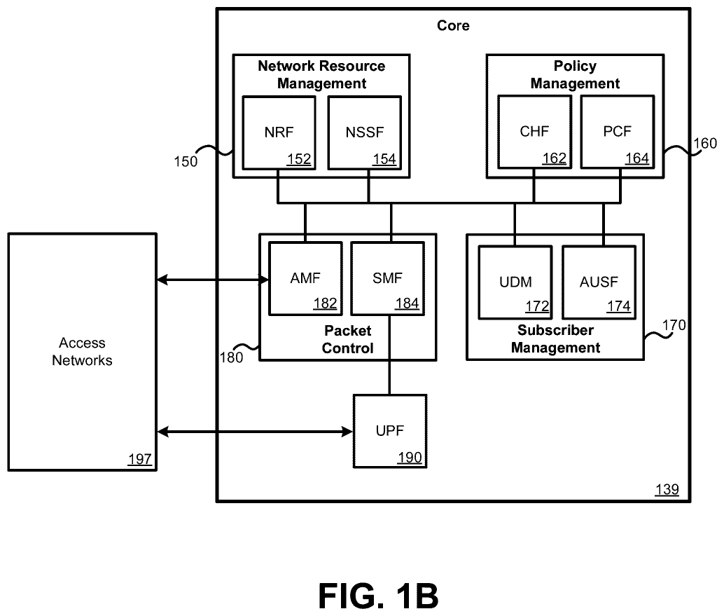

FIG. 1A illustrates an embodiment of a cellular network system 100 (“system 100”), according to certain embodiments. System 100 can include a fifth generation (5G) New Radio (NR) cellular network; other types of cellular networks, such as fourth generation (4G) long-term evolution (LTE) cellular network, sixth generation (6G) cellular network, seventh generation (7G) cellular network, etc. are also possible. System 100 can include: UE 110 (UE 110-1, UE 110-2, UE 110-3); base station 115; cellular network 120; radio units 125 (“RUs 125”); distributed units 127 (“DUs 127”); centralized unit 129 (“CU 129”); core 139, orchestrator 138, and devices 140 that are included within closed groups 142.

FIG. 1A represents a component level view. In a virtualized open radio access network (O-RAN), because components can be implemented as software in the cloud, except for components that receive and transmit RF, the functionality of various components can be shifted among different servers, for which the hardware may be maintained by a separate (e.g., public) cloud-service provider, to accommodate where the functionality of such components is needed.

UEs 110 and devices 140 can represent various types of devices, such as smartphones, cellular modems, cellular-enabled computerized devices, sensor devices, manufacturing equipment, gaming devices, access points (APs), any computerized device capable of communicating via a cellular network, etc. UE and devices can also represent any type of device that has incorporated a cellular (e.g., 5G) interface, such as a 5G modem. Examples include sensor devices, Internet of Things (IoT) devices, manufacturing robots; unmanned aerial (or land-based) vehicles, network-connected vehicles, environmental sensors, etc. UE 110 and devices 140 may use RF to communicate with various base stations of cellular network 120.

Two base stations 115 (BS 115-1, 115-2) are illustrated. Real-world implementations of system 100 can include many (e.g., hundreds, thousands) base stations, and many RUs, DUs, and CUs. BS 115 can include one or more antennas that allow RUs 125 (e.g., RU 125-1 and RU 125-2) to communicate wirelessly with UEs 110. RUs 125 can represent an edge of cellular network 120 where data is transitioned to wireless communication. In some implementations, the radio access technology (RAT) used by RU 125 is 5G New Radio (NR). Other implementations use other RAT, such as 4G Long Term Evolution (LTE). The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1) located on site at the base station. In some embodiments, the DU may be physically remote from the RU. For instance, multiple DUs may be housed at a central location and connected to geographically distant (e.g., within a couple of kilometers) RUs.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, “band 71” (a radiofrequency band near 600 Megahertz allocated for cellular communications). One or more DUs, such as DU 127-1, may communicate with CU 129. Collectively, RUs, DUs, and CUs create a gNodeB, which serves as the radio access network (RAN) of cellular network 120. CU 129 can communicate with core 139. The specific architecture of cellular network 120 can vary by embodiment. Edge cloud server systems outside of cellular network 120 may communicate, either directly, via the Internet, or via some other network, with components of cellular network 120. For example, one or more DUs 127-1 may be able to communicate with an edge cloud server system without routing data through CU 129 or core 139.

At a high level, the various components of a gNodeB can be understood as follows: RUs perform RF-based communication and the lower physical layer (L-PHY) with UE. DUs support lower layers of the protocol stack such as the radio link control (RLC) layer, the medium access control (MAC) layer, and the higher physical communication layer (H-PHY). CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

Further detail regarding exemplary core 139 is provided in relation to FIG. 1B. FIG. 1B illustrates an exemplary core 139, according to certain embodiments. The exemplary core 139 can be physically distributed across data centers or located at a central national data center (NDC), or at a regional data center (RDC), can perform various core functions of the cellular network. Core 139 can include: network resource management components 150; policy management components 160; subscriber management components 170; and packet control components 180. Individual components may communicate via a bus, thus allowing various components of core 139 to communicate with each other directly. Core 139 is simplified to show some key components. Implementations can involve additional components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE (e.g., UEs 110 of FIG. 1A), or devices 140.

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UEs.

Packet control components 180 can include: Access and Mobility Management Function (AMF) 182 and Session Management Function (SMF) 184. AMF 182 can receive connection- and session-related information from UEs and is responsible for handling connection and mobility management tasks. SMF 184 is responsible for interacting with the decoupled data plane, creating updating and removing Protocol Data Unit (PDU) sessions, and managing session context with the User Plane Function (UPF).

User plane function (UPF) 190 can be responsible for packet routing and forwarding, packet inspection, quality of service (QoS) handling, and external PDU sessions for interconnecting with a Data Network (DN) (e.g., the Internet) or various access networks 197. Access networks 197 can include the RAN of cellular network 120 of FIG. 1A.

While FIG. 1A and FIG. 1B illustrate various components of cellular network 120, it should be understood that other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In a virtualized arrangement, specialized software on general-purpose hardware may be used to perform the functions of components such as DU 127, CU 129, and core 139. Functionality of such components can be co-located or located at disparate physical server systems. For example, certain components of core 139 may be co-located with components of CU 129.

Returning to FIG. 1A, some O-RAN implementations of the DUs 127, CU 129, core 139, and/or orchestrator 138 are implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, core 139, and orchestrator 138.

In some examples, DUs 127 may be partially or fully added to cloud-based cellular network components 128. Such cloud-based cellular network components 128 may be executed as specialized software executed by underlying general-purpose computer servers. Cloud-based cellular network components 128 may be executed on a public third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested. A “public” cloud-based computing platform refers to a platform where various unrelated entities can each establish an account and separately utilize the cloud computing resources, the cloud computing platform managing segregation and privacy of each entity's data.

Kubernetes, or some other container orchestration platform, can be used to create and destroy the logical DU, CU, or 5G core units and subunits, as needed, for the cellular network 120 to function properly. Kubernetes allows for container deployment, scaling, and management. As an example, if cellular traffic increases substantially in a region, an additional logical DU or components of a DU may be deployed in a data center near where the traffic is occurring without any new hardware being deployed; rather, processing and storage capabilities of the data center would be devoted to the needed functions. When the need for the logical DU or subcomponents of the DU no longer exists (i.e., when traffic subsequently decreases), Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU, orchestrator 138 can perform a pipeline of calling the DU code from a software repository incorporated as part of, or separate from, cellular network 120; pulling corresponding configuration files (e.g., helm charts); creating Kubernetes nodes/pods; loading DU containers; configuring the DU; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1; and a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 1A, a portion of the UE 110 and/or a portion of the devices 140 may be operating on one or more production slices of cellular network 120. A UE that functions on a particular entity's local network may be assigned to a slice particular to the entity or a slice that provides a particular Quality of Experience (QoE) for tasks to be performed by the entity's UE.

Components such as DUs 127, CU 129, orchestrator 138, and core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

The capabilities of system 100 may also be described in terms of physical resource blocks (PRBs). A physical resource bock may refer to the smallest defined size of radio resource allocation which may be provided by system 100. A PRB may define how a radio spectrum is partitioned. One or more PRBs may be used for communication between a base station and a user device. A PRB may be defined over a frequency bandwidth and over a fixed specific time interval. For example, a PRB may be defined over a bandwidth (e.g., 180 kHz) over a slot of time (e.g., 1 ms). As further explained herein, PRBs may be managed through the disclosed technology to improve efficiency of energy consumption while meeting Quality of Service (QoS) requirements. The dynamic allocation of radio network resources, which may in one example be conceptualized or framed through the use of PRBs, is further discussed below. However, the disclosed technology is not limited to only formulations using PRBs but may expand to other formulations in connection with energy or cellular resources. In some examples, each PRB may also be associated with a quantum of energy.

As will be discussed in more detail below, the devices 140 are selected to be in closed groups 142 to perform a task/service. According to some configurations, one or more machine learning (ML) models may be used to determine the devices (e.g., IoT devices) that are available, alone and/or in combination, to perform a specified task/service. In some examples, a mesh network is formed between the devices 140 identified to perform a particular task. The use of closed groups a communication using a mesh network can assist to provide secure direct communication between the different devices that are part of closed group. In some examples, the devices within the group may use different communication techniques such as unicast, multicast, or broadcast.

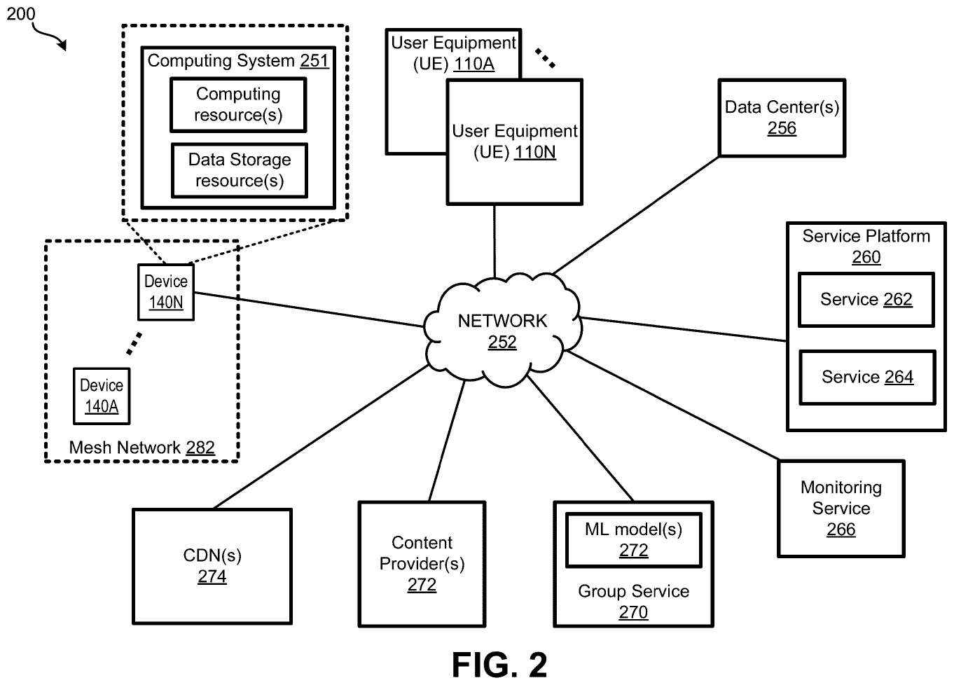

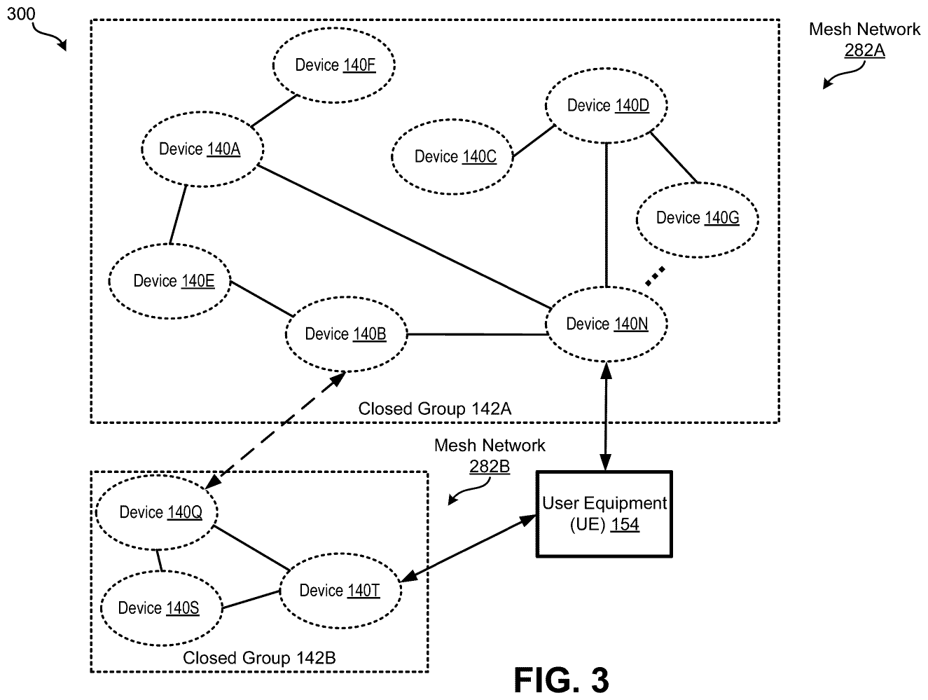

FIG. 2 is a schematic diagram illustrating an example communications system 200 that uses closed groups 142 of devices 140 to perform tasks/services, according to various embodiments. The system 200 includes one or more 5G devices 140, such as devices 140A-140N that form a closed group 142. In some examples, each of the 5G devices includes a computing system 251. The computing system 251 contains processing resources such as computing resources, memory device, and data storage resources. The 5G devices 140 are communicatively interconnected with each other through network 152, and in some configurations using a mesh network 282 (See FIG. 3 and related discussion). Further, the 5G devices 140 can also be connected to various user equipment 154, such as UE 110A-110N through the network 252. Also, user equipment 110 may include, or be part of, various types of devices including, but not limited to: smartphones, tablets, notebook computers, mobile devices, sensors, vehicles, autonomous vehicles, machinery, appliances, smart speakers, digital assistants, security cameras, monitoring devices, home electronics, media players, receiving devices, set-top boxes, other computing devices and IoT devices, etc.

Network 252 may also provide connectivity to other networks and geographically separated devices, such as service platform 260, monitoring service 266, and devices in data center(s) 256 (e.g., local data centers, regional data centers, national data centers), content provider(s) 272, content delivery network(s) 274, and group service 270. In some embodiments, network 252 includes the main mobile core network which provides subscriber profile information, subscriber location, authentication of services, and the necessary switching functions for voice and data sessions, including circuit-switched services, packet-switched services. Network 252 may also provide cloud-aligned, service-based architecture (SBA) that spans across various functions and interactions including authentication, security, session management, and aggregation of traffic from end devices.

Network 252 may also include equipment and provide functionality to provide Internet connectivity to the user equipment 110, devices 140, and connectivity to other devices and systems, such as service platform 260, monitoring service 266, and devices in data center(s) 256, content provider(s) 272, content delivery network(s) 274, and the group service 270, using other additional or integrated networks. For example, network 252 may include one or more computer networks, one or more wired or wireless networks, satellite transmission media, one or more cellular networks, the Internet or some combination thereof, including routers, switches, gateways and other network equipment providing such connectivity. The network 252 may include a publicly accessible network of linked networks, possibly operated by various distinct parties, such as the Internet. In some embodiments, the network is a 5G-based network, such as illustrated in FIG. 1A and FIG. 1B.

In some embodiments, the 5G devices 140 and/or UE 110 include a small-scale 5G cell (e.g., a 5G microcell, a 5G minicell, a 5G small cell, a 5G femtocell, or a 5G picocell, or the like). Generally, the small-scale 5G cells are mini cell sites or base stations designed for localized coverage typically from a few meters to a few hundred meters providing in-fill for a larger macro network. The 5G cells equipped on the 5G devices can provide 5G cellular network that further facilitate the communication among the 5G devices 140 as well as between the 5G devices 140 and the user equipment 110 that are in close proximity to the 5G devices.

As briefly discussed above, wireless devices 140 are identified to perform at least a portion of a task/service such that the combination of devices 140 can perform the complete task. In some configurations, a group service 270 may receive a request from a device 140 that is connected to a cellular network for the availability of other devices, or groups of devices (e.g., existing closed groups 142 established within the cellular network) that can be used to perform a task/service.

In response to receiving the request, the group service 270 can identify the available devices 140 within some proximity to the requesting device 140 (e.g., within a predetermined area, within a predetermined distance, . . . ) that are configured to perform at least a portion of the requested task/service. In some examples, the group service 270 uses one or more ML models 272 to identify the type(s) of devices 140 that are needed to perform the requested service/tasks, and the devices 140 available to perform the requested service/task. The ML models 272 may be trained and updated using data obtained directly from the different types of devices 140 available within the cellular network. In some examples, the group service 270 generates a recommendation of devices 140 that are available to form a closed group with the requesting device 140 and perform the task in coordination with the other devices within the closed group. The group service 270 transmits the recommendation to the requesting device 140.

As an example, the task may relate to locating a lost individual within a certain area (e.g., a neighborhood, a theme park, a building, . . . ). In some cases, the requesting device 140 may be located within the specified search area. In response to receiving the request, the group service 270 may identify one or more groups of devices 140 that can perform actions associated with locating the individual (e.g., cameras, tracking devices, . . . ). In some cases, one group of devices 140 may be identified within a specified building, whereas other devices 140 may be associated with other areas. The group service 270 provides the determined group(s)/device(s) that may assist in performing the task of locating the individual. The requesting device 140, or some other device/component may use the group(s)/devices 140 received from the group service 270 to create one or more closed groups and one or more mesh networks 282 to coordinate the communication for performing the task. In some cases, the different group(s)/devices 140 may report to each other information (e.g., possible locations of the lost individual).

After receiving the recommendation of the available devices 140 to perform the task, the requesting device 140, or some other component/device selects devices from the recommended devices to include within the group. Once the devices 140 are selected, the closed group is established. In some configurations, a mesh network 282 is established that includes the selected devices 140. According to some configurations, the devices 140 within the closed group may create different channels for communication that use different communication methods such as unicast, broadcast, and multi-cast. In some examples, one mesh network that is associated with a first closed group can establish a connection to communicate with one or more other mesh networks that are associated with different closed groups.

The group service 270 may employ one or more ML models 272 containing device selection optimization algorithm(s) for identifying devices to perform at least part of a task/service. The ML models 272 may be used to identify devices 140 to recommend based on capabilities (specified and/or measured) associated with the available devices 140. The capabilities and measurements can include but are not limited to throughput and packet loss rate, processing power, memory, provided functionality, and the like. The one or more ML models are configured to generate a recommendation as an output that indicates the devices 140 to include within a closed group 142 to perform a task. The group service 170 can also be configured to establish, develop, train, validate, and update one or more ML models 272.

The monitoring service 266 may include various monitoring tools for collecting real-time network performance metrics data. For example, a NetFlow analyzer may be used to monitor and analyze network traffic flows in real-time and provide visibility into network bandwidth usage, application performance, and security threats by analyzing flow data generated by the network devices. Simple Network Management Protocol (SNMP) may be used to collect and analyze performance data from network devices, monitor current health status of each device, traffic utilization, and other metrics. Bandwidth monitoring tools may be used to track network bandwidth usage in real-time, monitor traffic patterns, identify bandwidth-intensive applications, and detect abnormal usage patterns that may indicate network congestion or security threats. QoS analyzer may be used to assess network performance based on predetermined service level agreements (SLAs) or QoS parameters and determine if the real-time network performance is in compliance with QoS standards. APM tool may be used to collect data including metrics such as response time, throughput, error rates, CPU and memory utilization, database query performance, latency, and more, during execution of one or more applications.

Multi-Access Edge Computing (MEC) is an element of 5G architecture that can bring the applications from centralized data centers to the network edge, and therefore closer to end users and their devices. This essentially creates a shortcut in content delivery between the user and host, and the long network path that once separated them. Characteristics of the MEC include the low latency, last mile telecommunication, high bandwidth, high speed, and real time access to RAN information that distinguish 5G architecture from its predecessors. In some embodiments, this low latency, high bandwidth and real time access to an increasing number of small and macro 5G cells equipped on the 5G devices, is utilized in a unique way to tap into the available processing resources at these computing nodes.

FIG. 3 is a schematic diagram illustrating an example communications system 300 utilizing a mesh network 282A of 5G devices 140, and a second mesh network 282B, according to various embodiments. In some examples, the mesh network is implemented with the “ZigBee” networking protocol.

In the illustrated example of FIG. 3, a mesh network 282 is composed of a plurality of 5G devices 140 with each one of the 5G devices 140 serving as a computing node of the mesh network. The mesh network 282 can be communicatively connected to a cellular network, as well as other devices such as user equipment 110 and/or devices 140. The mesh network 282 allows for secure message transmission between the different devices that are within a closed group 142. In the current example, a first closed group 142A includes devices 140A-140N and a second closed group 142B includes devices 140Q, 104S, and 140T. As briefly discussed above, the processing resources from these 5G devices in the local mesh network can be coordinated to perform a task/service.

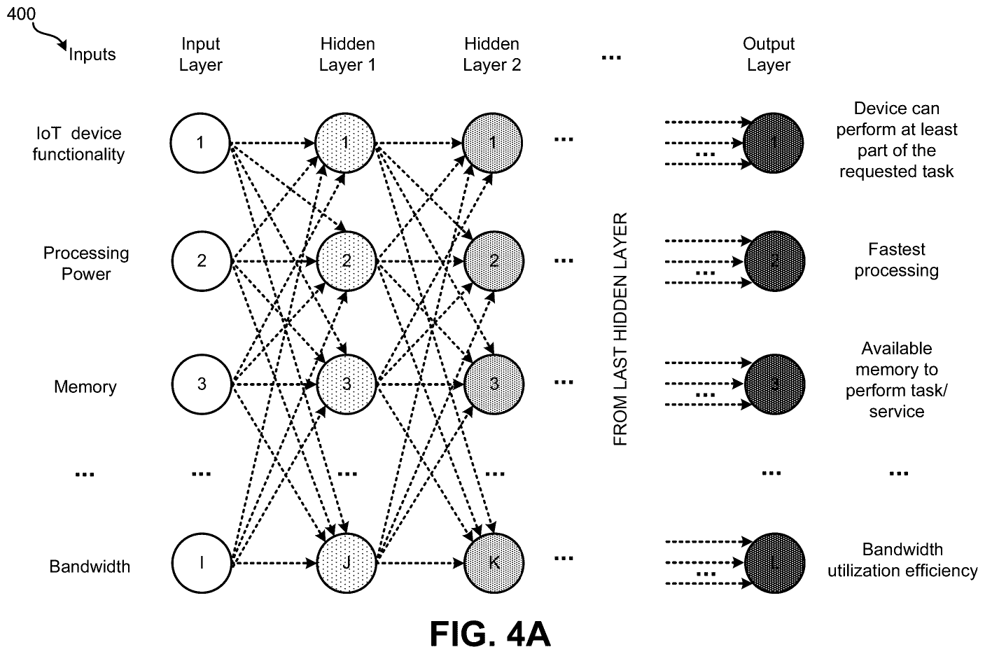

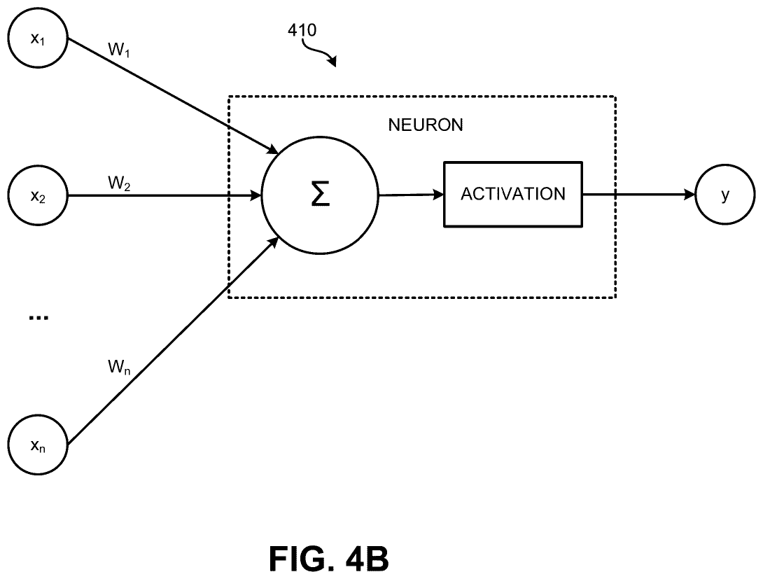

FIG. 4A illustrates an example of a neural network 400 that has been trained to generate a recommendation for devices to include within a closed group to perform a task, according to various embodiment of the present disclosure. The neural network 400 may be a GAN and include a number of hidden layers. Both deep learning neural networks (DLNNs) and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 400.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers. For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

As illustrated in FIG. 4A, various parameters such as IoT device functionality (e.g., parameters relating to functionality provided by the 5G device), processing power, memory, bandwidth, and the like are provided as the input layer are fed as inputs to the J neurons of hidden layer 1. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks (GANs), liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. It should be noted that numbers of neurons I, J, K, and L are not necessarily equal, and thus, any desired number of layers may be used for a given layer of neural network 400 without deviating from the scope of the present disclosure. Indeed, in certain embodiments, the types of neurons in a given layer may not all be the same.

It should be noted that neural networks are probabilistic constructs that typically have confidence score(s). This may be a score learned by the ML model based on how often a similar input was correctly identified during training. Some common types of confidence scores include a decimal number between 0 and 1 (which can be interpreted as a confidence percentage as well), a number between negative co and positive co, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 410 is shown in FIG. 4B. Inputs X₁, X₂, . . . , Xₙ, from a preceding layer are assigned respective weights W₁, W₂, . . . , Wₙ. Thus, the collective input from preceding neuron 1 is WᵢXᵢ. These weighted inputs are used for the neuron's summation function modified by a bias, such as:

$${\sum }_{i = 1}^{m} ( {W}_{i} {X}_{i} ) + bias \qquad ( 1 )$$

This summation is compared against an activation function f(x) to determine whether the neuron “fires”. For instance, f(x) may be given by

$$f ( X ) = \{ \begin{matrix}1 if {\sum }_{i = 1}^{m} ( {W}_{i} {X}_{i} ) + bias \geq 0 \\ 0 if {\sum }_{i = 1}^{m} ( {W}_{i} {X}_{i} ) + bias < 0\end{matrix} \qquad ( 2 )$$

The output y of neuron 310 may thus be given by:

$$y = f ( X ) {\sum }_{i = 1}^{m} ( {W}_{i} {X}_{i} ) + bias \qquad ( 3 )$$

In this case, neuron 410 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the present disclosure.

The goal, or “reward function” is often employed, such as for this selecting the best devices to perform the task or the requested task. A reward function explores intermediate transitions and steps with both short-term and long-term rewards to guide the search of a state space and attempt to achieve a goal (e.g., determining when the network is likely to be congested, identifying the optimal bitrate, etc.).

During training, various labeled data (e.g., device data, device functionality, network performance data, device operating status data, . . . ) are fed through neural network 400. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the ML model is not improving after a certain number of training iterations, the reward function may be modified to provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions fᵢ between each layer i=1, . . . , N of the network, with the output at a given layer first multiplied by a synaptic matrix Wi, and with a bias vector bi added. The network output o, given by:

$$o = {f}_{N} ( {W}_{N} {f}_{N - 1} ( {W}_{N - 1} {f}_{N - 2} ( … {f}_{1} ( {W}_{1} X + {b}_{1} ) … ) + {b}_{N - 1} ) + {b}_{N} ) \qquad ( 4 )$$

In some embodiments, o is compared with a target output t, resulting in an error (E), which is expressed below and desired to be minimized:

$$E = \frac{1}{2} {‖ o - t ‖}^{2} \qquad ( 5 )$$

Optimization in the form of a gradient descent procedure may be used to minimize the error by modifying the synaptic weights Wᵢ for each layer. The gradient descent procedure requires the computation of the output o given an input x corresponding to a known target output t, and producing an error (o−t). This global error is then propagated backwards giving local errors for weight updates with computations similar to, but not exactly the same as, those used for forward propagation. In particular, the backpropagation step typically requires an activity function of the form pⱼ(nⱼ)=fⱼ′(nⱼ), where nⱼ is the network activity at layer j (i.e., nⱼ=WⱼOⱼ₋₁+bⱼ) where oⱼ=fⱼ(nⱼ) and the apostrophe ' denotes the derivative of the activity function f.

The weight updates may be computed via the formulae:

$${d}_{j} = \{ \begin{matrix}( o - t ) ∘ {p}_{j} ( {n}_{j} ) , j = N \\ {W}_{j = 1}^{T} {d}_{j + 1} ∘ {p}_{j} ( {n}_{j} ) , j < N\end{matrix} \qquad ( 6 )$$

$$\frac{\partial E}{\partial {W}_{j + 1}} = {{d}_{j + 1} ( {o}_{j} )}^{T} \qquad ( 7 )$$

$$\frac{\partial E}{\partial {b}_{j + 1}} = {d}_{j + 1} \qquad ( 8 )$$

$${W}_{j}^{new} = {W}_{j}^{old} - η \frac{\partial E}{\partial {W}_{j}} \qquad ( 9 )$$

$${b}_{j}^{new} = {b}_{j}^{old} - η \frac{\partial E}{\partial {b}_{j}} \qquad ( 10 )$$

where o denotes a Hadamard product (i.e., the element-wise product of two vectors), T denotes the matrix transpose, and oⱼ denotes fⱼ(WⱼOⱼ₋₁+bⱼ), with oₒ=X. Here, the learning rate f is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The ML model 272 may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the ML model may be tested on a set of evaluation data that the ML model has not encountered before. This helps to ensure that the ML model is not “over fit” such that it performs well on the training data, but does not perform well on other data.

In some embodiments, it may not be known what accuracy level is possible for the ML model to achieve. Accordingly, if the accuracy of the ML model is starting to drop when analyzing the evaluation data (i.e., the model is performing well on the training data, but is starting to perform less well on the evaluation data), the ML model may go through more epochs of training on the training data (and/or new training data). In some embodiments, the ML model is only deployed if the accuracy reaches a certain level or if the accuracy of the trained ML model is superior to an existing deployed ML model. In certain embodiments, a collection of trained ML models may be used to accomplish a task. This may collectively allow the ML models to enable semantic understanding to better predict event-based congestion or service interruptions due to an accident, for instance.

In some embodiments, transformer networks may be used. Examples of the transformer network includes SentenceTransformers™, which is a Python™ framework for state-of-the-art sentence, text, and image embeddings. Such transformer networks learn associations of words and phrases that have both high scores and low scores. This trains the ML model to determine what is close to the input and what is not, respectively. Rather than just using pairs of words/phrases, transformer networks may use the field length and field type, as well.

Natural language processing (NLP) techniques such as word2vec, BERT, GPT-3.5, etc. may be used in some embodiments to facilitate semantic understanding. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DB SCAN clustering algorithm, the Gaussian mixture model (GMM) algorithms, the balance iterative reducing and clustering using hierarchies (BIRCH) algorithm, etc. Such techniques may also assist with categorization.

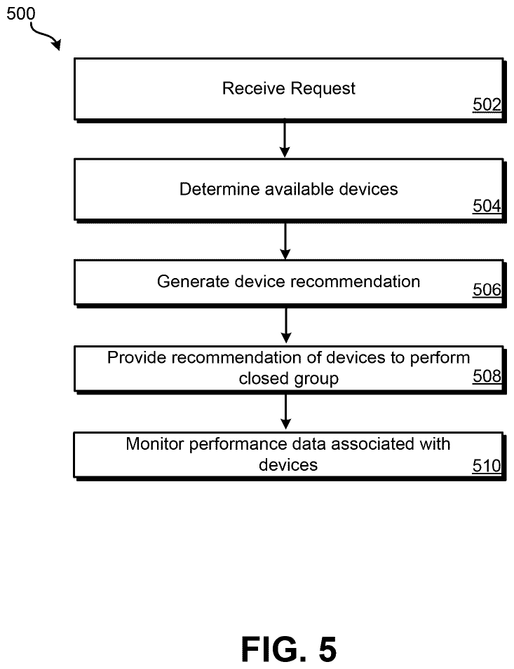

FIG. 5 is a flow diagram illustrating a process 500 for generating a recommendation that identifies available devices within a cellular network to perform a task.

At 502, a request is received. As discussed above, the request includes an indication of a task/service that is to be performed by devices within a closed group. In some examples, the request is transmitted by a device 140 that will be part of the closed group and will perform functionality related to the task. In other examples, the request could be transmitted by a different device. For example, the request could be a voice command captured using a voice assistant or some other mechanism. In other examples, the request may be made by selection of or interaction with one or more user interface elements within a user interface.

At 504, available devices within the network are identified. In some examples, the group service 270 identifies devices that are within a specified distance from the requesting device such that a mesh network can be established. Other parameters may also be used to identify the devices, such as but not limited to processing power, memory, storage, bandwidth, and the like.

At 506, a device recommendation is generated. As discussed above, in some examples, a group service 270 uses one or more ML models to determine devices within a cellular network that can perform at least a portion of the requested task such that the combination of recommended devices (including the requesting device in some examples) can perform the task/service. In some configurations, the recommended devices are within a specified distance from the requesting device.

At 508, the recommendation is provided to the requesting device. As discussed above, the group service 270 may transmit the recommendation that identifies the devices and/or other information (e.g., type of devices, identifiers of the devices, . . . ).

At 510, the devices are monitored. As discussed above, the monitoring service 266, the group service 270, or some other device/component may monitor the devices 140 to obtain performance data related to the performance of the task.

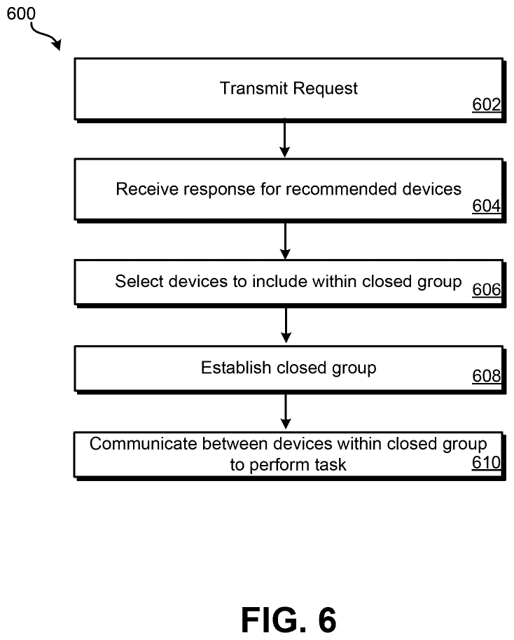

FIG. 6 is a flow diagram illustrating a process 600 for establishing and using a closed group of devices to perform a task.

At 602, a request is transmitted. As discussed above, the request includes an indication of a task/service that is to be performed by devices within a closed group. In some examples, the request is transmitted by a device 140 to a component, such as group service 270.

At 604, a response that includes recommended devices is received. As discussed above, the recommended devices can be determined using one or more ML models and are identified as being capable of performing at least a portion of the requested task such that the combination of recommended devices (including the requesting device in some examples) can perform the task/service.

At 606, devices to include within the closed group can be selected. As discussed above, the requesting device 140, or some other device or component, can select the devices used to establish one or more closed groups. In some examples, each of the recommended devices 140 may be included within the one or more closed groups.

At 608, the closed group is established. As discussed above, in some examples, a mesh network 182 is established for the devices 140 to use to securely communicate associated with the performance of the task.

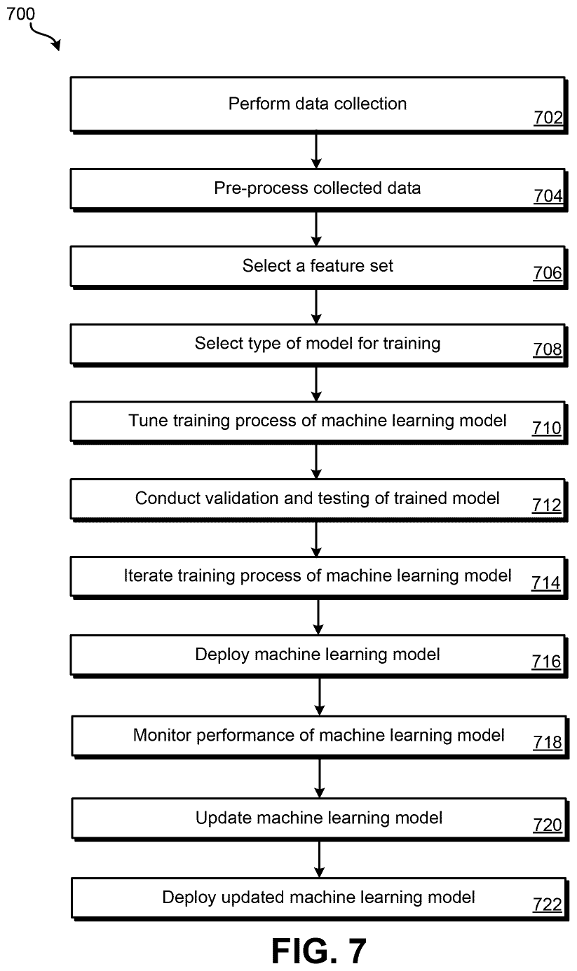

FIG. 7 a flow diagram illustrating a process 700 for training and updating one or more ML models for use in configurations disclosed herein. Once trained, the trained ML model may be used. For example, at process block 506 referenced above with respect to FIG. 5. In some examples, the trained ML model may be updated over time and deployed for use.

Prior to discussion of method 700, an overview of a machine learning process, including inputs and outputs given to a machine learning model, is provided. The machine learning and training process may include any of the following features or methods for training. In some examples, supervised learning models may be used. In this example, models may be trained on a labeled dataset. For instance, each training example for the machine learning model may be paired with an output label. In the training process, the model learns to predict an output from an input set of data. Examples may include linear regression for continuous outputs and logistic regression, support vector machines (SVMs), and neural networks for categorical outputs. Additional examples may include unsupervised learning models. Such models work with unlabeled data. Techniques which may be used include clustering (e.g., k-means, hierarchical clustering) and dimensionality reduction (e.g., principal component analysis, auto-encoders, etc.). Other examples may include semi-supervised learning processes. This involves a combination of a small amount of labeled data and a large amount of unlabeled data. The model leverages the labeled data to learn better representations of the unlabeled data, improving its performance.

In some examples, reinforcement learning techniques may be used. In some examples, models may be trained or “learn” to make sequences of decisions by interacting with an environment to achieve a goal. The learning is guided by rewards, where the model seeks to maximize its total reward. Examples include game playing, robotic navigation, and online recommendation systems.

In some examples, additional types of machine learning models, techniques, or training methods may be used. In some examples, a Recurrent Neural Network (RNN) may be used. A Recurrent Neural Network (RNN) is a class of artificial neural networks where connections between nodes form a directed graph along a temporal sequence. This structure allows RNNs to exhibit temporal dynamic behavior and to process sequences of inputs. This makes them particularly suitable for applications where the time aspect of data is useful. RNN architecture involves a layer of neurons that are connected in a loop, allowing information to persist. Variants of the RNN network, including Long Short-Term Memory (LSTM) may be used. LSTM is designed to overcome a problem of a vanishing gradient in RNNs and is capable of achieving learning long-term dependencies. Gated Recurrent Units, which are a simplified version of LSTMs may also be used. GRUs use a different gating mechanism than LSTMs and are effective at capturing long-term dependencies.

Convolutional Neural Networks (CNNs) are a specialized kind of Deep Neural Networks. CNNs are composed of multiple layers that transform the input volume (such as an image) into an output volume (e.g., class scores) through a series of differentiable operations.

At 702, data collection can be performed that is used to train a machine learning model. In some examples, the data collection is associated with characteristics of the devices 140 that are available within the cellular network. The characteristics may be specified by the vendor and/or observed from monitoring the devices 140. This information may be based on historical data or a set of training or testing data.

At 704, the collected data may be pre-processed. This may include normalization of the data, removing or reducing data with high correlation, or simplifying or removing certain types of data. The removal of certain types of data or simplification may be useful for the purpose of training. Simplification of certain types of data may improve performance of the machine learning model.

At 706, a feature set may be selected. This may include the features or set of features which are most relevant to the selection of devices 140 to recommended to perform a requested task. Any subset of features may be also selected at this block. In some examples, multiple feature sets may be selected for training. The feature set which is determined to be most significant may later be selected.

At 708, a type of ML model may be selected for training. This may include classification models, regression models, or neural networks. In some examples, multiple neural networks may be chosen and trained, and tested for predictive accuracy. This may include neural networks with varying numbers of intermediate layers or hidden layers. The number of nodes in each layer, including the input layer, output layer, and hidden layers may also be varied in choosing a suitable machine learning model. In some examples, the neural network may be chosen based on accuracy for a subset of training data which is thought to be most common. In some examples, iterative and non-iterative processes described above may be used to determine or generate training data for training a model. In some examples, multiple models may be selected for training.

At 710, tuning of the training process or model may take place. Tuning may include changing or adjusting hyperparameters. A hyperparameter is a parameter, such as the learning rate or choice of optimizer, which specifies details of the learning process. This may include finding the best configuration of hyperparameters which maximizes the predictive accuracy and minimizes the error on a validation dataset.

At 712, validation and testing may take place. This may include validating the trained model on a separate dataset which is not used to train to model to evaluate the model's performance.

At 714, the training process may be iterated by enhancing the training dataset. This may include providing additional data, selecting different features or parameters to train the model, selecting a new algorithm or training method, or changing features of a neural network. Additionally, the model may be monitored and retrained based on new data which is received.

At 716, the ML can be deployed. Once the ML model is deployed, the group service 270 can use the ML model to generate recommendations of the devices 140.

At 718, after deployment, the group service 270, or some other device/component can monitor the performance of the ML model to ensure it meets the expected improvement metrics. Feedback on its performance is collected continuously.

At 720, the ML model can be updated to increase the performance of the ML model. If areas of improvement or dissatisfaction are identified, these insights, and additional training data, can trigger a new cycle of updates, starting again from 702.

At 722, the updated ML model can be deployed.

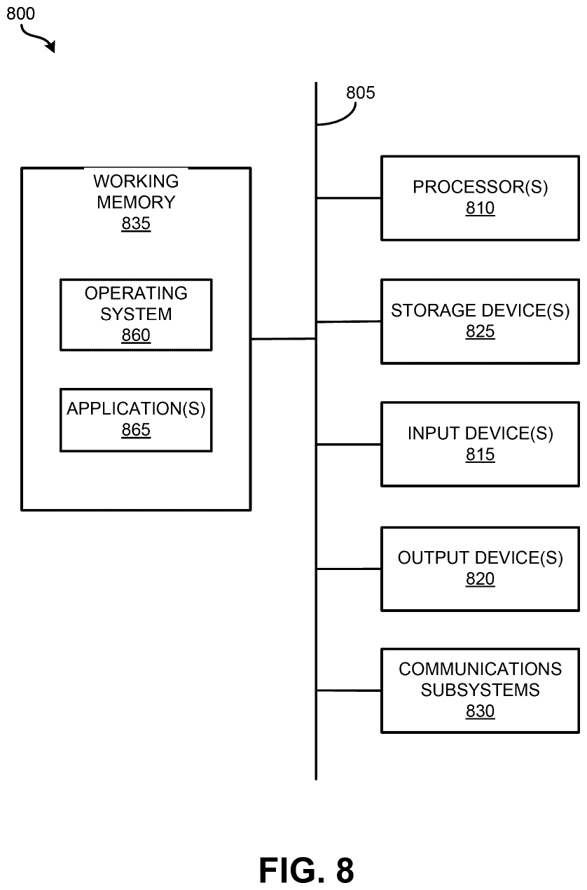

FIG. 8 provides a schematic illustration of one embodiment of a computer system 800 that can perform some or all of the steps of the methods and workflows provided by various embodiments. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner.

The computer system 800 is shown including hardware elements that can be electrically coupled via a bus 805, or may otherwise be in communication, as appropriate. The hardware elements may include one or more processors 810, including without limitation one or more general-purpose processors and/or one or more special-purpose processors such as digital signal processing chips, graphics acceleration processors, and/or the like; one or more input devices 815, which can include without limitation a mouse, a keyboard, a camera, and/or the like; and one or more output devices 820, which can include without limitation a display device, a printer, and/or the like.

The computer system 800 may further include and/or be in communication with one or more non-transitory storage devices 825, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 800 might also include a communications subsystem 830, which can include without limitation a modem, a network card (wireless or wired), an infrared communication device, a wireless communication device, and/or a chipset such as a Bluetooth™ device, a 802.11 device, a WiFi device, a WiMax device, cellular communication facilities, etc., and/or the like. The communications subsystem 830 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 830. In other embodiments, a portable electronic device, e.g., the first electronic device, may be incorporated into the computer system 800, e.g., an electronic device as an input device 815. In some embodiments, the computer system 800 will further include a working memory 835, which can include a RAM or ROM device, as described above.

The computer system 800 also can include software elements, shown as being currently located within the working memory 835, including an operating system 860, device drivers, executable libraries, and/or other code, such as one or more application programs 865, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 8, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 825 described above. In some cases, the storage medium might be incorporated within a computer system, such as computer system 800. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 800 and/or might take the form of source and/or installable code, which, upon compilation and/or installation on the computer system 800 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 800 to perform methods in accordance with various embodiments of the technology. According to a set of embodiments, some or all of the operations of such methods are performed by the computer system 800 in response to processor 810 executing one or more sequences of one or more instructions, which might be incorporated into the operating system 860 and/or other code, such as an application program 865, contained in the working memory 835. Such instructions may be read into the working memory 835 from another computer-readable medium, such as one or more of the storage device(s) 825. Merely by way of example, execution of the sequences of instructions contained in the working memory 835 might cause the processor(s) 810 to perform one or more procedures of the methods described herein. Additionally, or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 800, various computer-readable media might be involved in providing instructions/code to processor(s) 810 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 825. Volatile media include, without limitation, dynamic memory, such as the working memory 835.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800.

The communications subsystem 830 and/or components thereof generally will receive signals, and the bus 805 then might carry the signals and/or the data, instructions, etc. carried by the signals to the working memory 835, from which the processor(s) 810 retrieves and executes the instructions. The instructions received by the working memory 835 may optionally be stored on a non-transitory storage device 825 either before or after execution by the processor(s) 810.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a segment” includes a plurality of such segments, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

As used herein, “media content,” “media program,” “multimedia content,” “content,” or variants thereof should be understood as referring to any audiovisual programming or content in any streaming, file-based, or another format. The media content generally includes data that, when processed by a media player or decoder, allows the media player or decoder to present a visual and/or audio representation of the corresponding program content to a viewer (i.e., the user of a client device including the media player or decoder). In one or more embodiments, a media player can be realized as a piece of software that plays multimedia content (e.g., displays video and plays audio).

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

1. A method for secured closed group services over a cellular network, comprising:
receiving, by one or processors, a request from a device within a cellular network, wherein the request indicates a recommendation for other devices within the cellular network that are available to form a closed group of devices capable of performing a task;
determining, by the one or more processors, the other devices that are available within the cellular network and that at least in combination with the device are able to perform the task; wherein the determining includes use of one or more machine learning (ML) models;
generating, by the one or more processors, a response that identifies the other devices that, at least in combination with the device, are available to participate with the device to perform the task; and
sending, by the one or more processors, the response to the device.

2. The method of claim 1, wherein the response causes the device to establish the closed group with one or more of the other devices; and directly communicate with the other one or more of the other devices to perform the task.

3. The method of claim 2, further comprising establishing a mesh network that includes the one or more of the other devices.

4. The method of claim 2, further comprising:
obtaining performance data relating to the performance of the task by one or more other devices of the closed group;
updating at least one of the one or more ML models using at least a portion of the performance data as a training input; and
deploying an updated ML model.

5. The method of claim 2, wherein establishing the closed group includes establishing a mesh network that includes the device and the one or more other devices; wherein the device communicates with the one or more other devices using at least one of unicast messages, or multi-cast messages.

6. The method of claim 1, wherein the other devices are 5G connected IoT devices.

7. The method of claim 1, further comprising wherein determining the other devices comprises determining one or more groups of devices that are configured to perform at least a portion of the task.

8. A system, comprising:
a device wirelessly connected to a cellular network; and
a group service wirelessly connected to the cellular network that is configured to:
receive a request from the device, wherein the request indicates a recommendation for other devices within the cellular network that are available to form a closed group of devices capable of performing a task;
determine the other devices that are available within the cellular network and that at least in combination with the device are able to perform the task; wherein the determining includes use of one or more machine learning (ML) models;
generate a response that identifies the other devices that, at least in combination with the device, are available to participate with the device to perform the task; and
provide the response to the device.

9. The system of claim 8, wherein the device is configured to:
determine selected devices from the other devices; and
establish the closed group with selected devices.

10. The system of claim 8, wherein the device is configured to:
establish a closed group with one or more of the other devices; and
directly communicate with the other one or more of the other devices to perform the task.

11. The system of claim 10, wherein the device is further configured to establish a mesh network that includes the one or more of the other devices.

12. The system of claim 9, wherein the group service is further configured to:
obtain performance data relating to the performance of the task by one or more other devices of the closed group;
update at least one of the one or more ML models using at least a portion of the performance data as a training input; and
deploy an updated ML model.

13. The system of claim 9, wherein establishing the closed group includes establishing a mesh network that includes the device and the one or more other devices; wherein the device communicates with the one or more other devices using at least one of unicast messages, or multi-cast messages.

14. The system of claim 8, wherein the device and the other devices are 5G IoT devices.

15. The system of claim 8, wherein determining the other devices comprises determining one or more groups of devices that are configured to perform at least a portion of the task.

16. A non-transitory computer-readable storage media storing computer-executable instructions that when executed by the one or more processors, cause the one or more processors to:
receive a request from a device within a cellular network, wherein the request indicates a recommendation for other devices within the cellular network that are available to form a closed group of devices capable of performing a task;
determine the other devices that are available within the cellular network and that at least in combination with the device are able to perform the task; wherein the determining includes use of one or more machine learning (ML) models;
generate a response that identifies the other devices that, at least in combination with the device, are available to participate with the device to perform the task; and
send the response to the device.

17. The non-transitory computer-readable storage media of claim 16, wherein the device directly communicates with the one or more of the other devices, within the closed group, to perform the task.

18. The non-transitory computer-readable storage media of claim 16, wherein the computer-executable instructions when executed, cause the one or more processors to establish a mesh network that includes the one or more of the other devices.

19. The non-transitory computer-readable storage media of claim 16, wherein the device and the one or more other devices communicate using secured communication channels.

20. The non-transitory computer-readable storage media of claim 16, wherein the device and the other devices are 5G IoT devices.
